(19) United States
(12) Patent Application Publication
(10) Pub. No.: US 2010/0294886 A1
(43) Pub. Date: Nov. 25, 2010

(54) SEAT DEVICE, PARTICULARLY AIRPLANE SEAT DEVICE

(75) Inventor: Jürgen Baumann, Bodman-Ludwigshafen (DE)

Correspondence Address: POSZ LAW GROUP, PLC, 12040 SOUTH LAKES DRIVE, SUITE 101, RESTON, VA, 20191, US

(73) Assignee: RECARO Aircraft Seating GmbH & Co., KG, Schwabisch Hall (DE)

(21) Appl. No.: 12/734,071

(22) PCT Filed: Oct. 6, 2008
(86) PCT No.: PCT/EP2008/008417

§ 371 Date: May 20, 2010

(30) Foreign Application Priority Data
Oct. 10, 2007 (DE) 10 2007 048 687.3

(51) Int. Cl. B64D 11/06; B60N 2/62

(52) U.S. Cl. 244/122 R

(57) ABSTRACT

A seat device, in particular an aircraft seat device, with a bearing unit and with a seat unit which is mounted movably by means of the bearing unit, with a locking unit for locking the seat unit in at least one position, and with an overload protection unit which permits movement of the seat unit in the event of an overload.

It is proposed that the overload protection unit has a delay unit which is provided in order to bring about a delay at least over a large part of an overload displacement.

### CROSS REFERENCE TO RELATED APPLICATIONS

This application is a U.S. national stage application of PCT/EP2008/008417 filed on Oct. 6, 2008, and claims priority to, and incorporates by reference, German patent application No. 10 2007 048 687.3 filed on Oct. 10, 2007.

### BACKGROUND

The invention is based on a seat device.

DE 102 09 184 A1 discloses a seat device with a bearing unit and with a seat unit which is mounted movably by means of the bearing unit and is formed by a lower leg supporting unit, a locking unit for locking the seat unit in various positions, and with an overload protection unit which permits movement of the seat unit in the event of an overload situation. The overload protection unit comprises a coupling which is integrated into the locking unit and which releases the locking unit lock in the event of an overload.

### SUMMARY

The invention is based on a seat device, in particular an aircraft seat device, with a bearing unit and with a seat unit which is mounted movably by means of the bearing unit, with a locking unit for locking the seat unit in at least one position, and with an overload protection unit which permits movement of the seat unit in the event of an overload situation.

It is proposed that the overload protection unit has a delay unit which is provided in order to bring about a delay, preferably a uniform delay, at least over a large part of an overload displacement. In this case, an “overload protection unit” is to be understood in particular as meaning a unit which is configured to an overload force which in particular is greater than load forces occurring on the seat unit during regular use, and in particular is provided in order to avoid damage to the bearing unit, the locking unit, the seat unit and/or an actuator unit due to excessive load forces. An “overload displacement” is to be understood in particular as meaning a displacement which is the maximum which the seat unit can execute in the event of an overload situation, wherein a large part is to be understood as meaning at least 50%, preferably at least 70%, and particularly preferably at least 80% of the displacement distance. A “delay unit” is to be understood in particular as meaning a unit which is provided specifically in order to counteract an acceleration of the seat unit in an overload situation and to brake the movement of said seat unit such that, at least after an initial acceleration, in anticipated overload situations the seat unit experiences an acceleration which is less than 80%, is preferably less than 60% and in particular is preferably less than 40% of the gravitational acceleration of 9.81 m/s². Furthermore, “provided” is to be understood in particular as meaning specially equipped, laid out and/or programmed.

An appropriate configuration can result in advantageously comfortable overload protection by means of which abrupt changes in the speed of, and sudden discharges of tension from, the seat devices and resultantly induced losses in comfort and possibly resultingly induced injuries to an operator can be reliably avoided.

The delay unit can have a brake unit and/or preferably an energy storage unit, thus enabling the kinetic energy of the seat unit to be advantageously stored in an overload situation in order to be subsequently used again, such as preferably for resetting the seat unit and particularly advantageously for automated resetting. In this case, “automated resetting” is to be understood in particular as meaning that the seat unit is automatically reset, i.e. without the intervention of an operator, from a position into which the seat unit is guided by an overload effect during an overload event, preferably into the initial position of the seat unit prior to the overload situation once the overload is removed.

The energy storage unit is preferably provided such that it continues to be charged over a large part of the overload displacement of the seat unit, which in particular is intended to mean that the energy in the energy storage unit continues to increase over at least 50% of the displacement distance of the overload displacement.

The energy storage unit can be formed by various units appearing expedient to a person skilled in the art, such as, for example, by an electrochemical storage unit, such as in particular by an accumulator, and/or particularly advantageously by a spring unit which is provided in order to continue to be pretensioned in an overload situation.

The spring unit can have various spring members, such as helical compression springs, torsion springs and/or gas-pressurized springs, which can be integrated in a particularly space-saving manner.

In a further embodiment of the invention, it is proposed that the spring unit has a prestressing force laid out to an overload force such that the spring is deflected and the seat unit can be moved only upon occurrence of a certain overload. An appropriate configuration can enable a complicated triggering mechanism to be avoided and particularly reliable triggering of the overload protection unit can be achieved in a particularly simple manner.

Furthermore, it is proposed that the overload protection unit is provided in order to be triggered in the overload situation when the locking unit is locked. By an appropriate configuration, the locking unit and the delay unit can be designed advantageously with regard to the functions thereof preferably separately from each other, and in particular the locking unit can advantageously be protected from an undesirably high load, in particular if the delay unit and preferably an energy storage unit of the overload protection unit are arranged upstream of the locking unit in a force flux originating from the seat unit. In this case, the locking unit can be formed by various units appearing expedient to a person skilled in the art, such as by a mechanical latching unit, an electric unit and/or by a hydraulic unit, such as by a hydraulic cylinder, which preferably remain in the locking position thereof during an overload situation.

In addition, space-saving integration can be achieved if the overload protection unit comprises at least one torsion unit, and in particular if the torsion unit has at least two torsion rods which are mounted rotatably relative to each other in an overload situation and are preferably rotated together in a normal operating mode such that there is no relative movement between the torsion rods. In this case, a torsion rod is to be understood as meaning both a solid shaft and advantageously also a hollow shaft, which shafts may have various cross-sectional profiles appearing expedient to a person skilled in the art, but particularly preferably have a round cross-sectional profile. The rods here are preferably mounted at least partially one inside the other, thus again enabling construction space to be saved.

Furthermore, components, construction space, weight, installation effort and costs can be saved if the torsion unit is provided in order to transfer a locking torque, in particular if the locking unit is arranged in a first side region of the torsion unit and the delay unit is arranged in a second side region of the torsion unit, which side region is arranged opposite the first side region. If the torsion unit is formed by a torsion rod, a side region is to be understood as meaning in particular an end region of the torsion rod, and therefore the locking unit is arranged in a first end region and the delay unit is arranged in a second end region of the torsion rod, which end region lies opposite the first end region.

As an alternative, the delay unit and the locking unit can also be arranged in a common side region of the seat device, thus short force flux distances between the delay unit and the locking unit can be enabled and, in association therewith, high degrees of rigidity can be achieved.

The seat device preferably includes a lever mechanism, the delay unit advantageously being connected to at least one lever and preferably to at least two levers of the lever mechanism. Advantageous transmission ratios can be achieved in a simple manner by means of an appropriate design and, in particular, in the case of an energy storage unit comprising a spring unit, a long spring deflection can be realized in a simple manner.

The seat unit may be formed by various units appearing expedient to a person skilled in the art, such as preferably by a backrest unit or particularly advantageously by a lower leg supporting unit. However, in the case of a lower leg supporting unit, a particularly comfortable effect can be achieved with a high degree of safety using a corresponding delay unit.

In a further embodiment, a seat with a seat device according to the invention is proposed, the seat in particular having a stand surface and the bearing unit of the seat device being provided in order to align the seat unit, which is formed by the lower leg supporting unit, substantially parallel to the stand surface. In this case, “substantially parallel” is intended in particular to mean that a supporting surface of the seat unit encloses an angle of less than 30°, preferably less than 20° and particularly advantageously less than 10° with respect to the stand surface about a pivot axis of the seat unit.

### BRIEF DESCRIPTION OF THE DRAWINGS

Further advantages emerge from the description of the drawings below. The drawings illustrate an exemplary embodiment of the invention. The drawings, the description and the claims contain numerous features in combination. A person skilled in the art will expediently also consider the features individually and put them together to form meaningful further combinations.

FIG. 1 is a first side view of an aircraft seat illustrated in schematized form,

FIG. 2 is a second side view of the aircraft seat of FIG. 1, and

FIG. 3 a cutout of the aircraft seat in a top view.

### DETAILED DESCRIPTION OF THE PREFERRED EMBODIMENTS

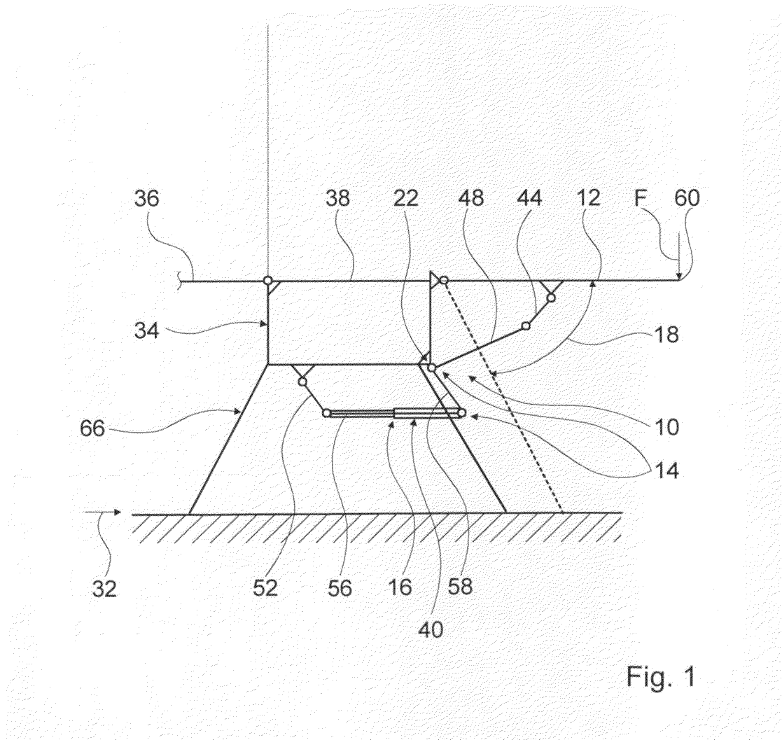

FIG. 1 shows a first side view of an aircraft seat with an aircraft seat device. The seat device has a base frame unit 34 and a stand surface 32 which is formed by a leg device 66 and by means of which the aircraft seat is erected on an aircraft floor and which is oriented parallel to the aircraft floor. The base frame unit 34 is arranged in a positionally fixed manner relative to the stand surface 32, but advantageously could be mounted movably relative to the stand surface 32 via a bearing unit.

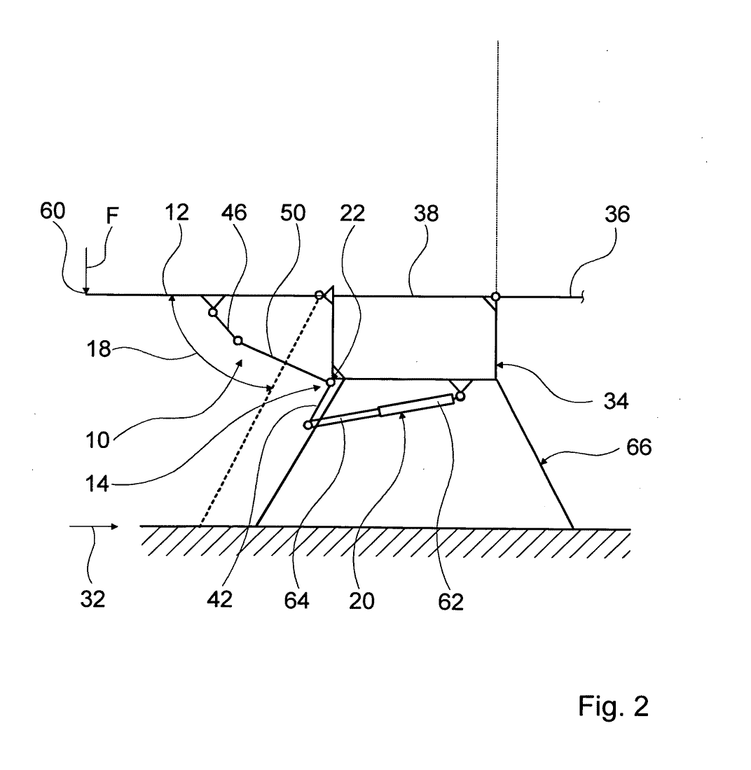

The aircraft seat includes a seat unit 36 formed by a backrest unit, a seat unit 38 formed by a seat base and a seat unit 12 formed by a lower leg supporting unit. The aircraft seat device comprises a bearing unit 10 which is formed by a lever mechanism and by means of which the seat unit 12, which is formed by the lower leg supporting unit, is mounted pivotably, to be precise, between an end position aligned substantially perpendicularly to the stand surface 32 and an end position aligned parallel to the stand surface 32. In FIGS. 1 and 2, the aircraft seat is illustrated in its bed position in which the seat unit 12 is arranged in its end position aligned parallel to the stand surface 32, while an upright seat position of the aircraft seat is indicated by dashed lines in FIGS. 1 and 2.

In addition, the aircraft seat device comprises a locking unit formed by an actuator, with an electromotive spindle drive which has an electric motor 62 and a driving spindle 64. The spindle drive includes a pair of matched threads such that, although the seat unit 12 can be moved by means of the electric motor 62, in the event of a force acting on the spindle drive from the seat unit 12 without driving of the electric motor 62, self-locking and therefore a lock occurs. By means of the actuator, the seat unit 12 can be moved and locked in and between the end positions. Instead of an electromotive spindle drive, other actuators and/or locking means appearing expedient to a person skilled in the art, such as in particular a hydraulic cylinder unit, etc., are also conceivable.

Furthermore, the aircraft seat device comprises an overload protection unit 14 which permits movement of the seat unit 12 in the event of an overload situation (FIGS. 1, 2 and 3). The overload protection unit 14 has a delay unit 16 which is formed by an energy storage unit, to be precise by a spring unit 40, and which is provided in order to bring about a delay along an overload displacement 18 from the end position in which the seat unit 12 is aligned parallel to the stand surface 32 as far as the end position in which the seat unit 12 is aligned substantially perpendicularly to the stand surface.

The overload protection unit 14 has a torsion unit 22 with an outer torsion rod 24 designed as a hollow shaft and an inner torsion rod 26 which is arranged coaxially in the outer torsion rod 24 and is designed as a hollow shaft, which torsion rods, in normal operation, are mounted rotatably about their longitudinal axis as a unit, without any movement relative to each other, and, in an overload situation, are mounted rotatably relative to each other.

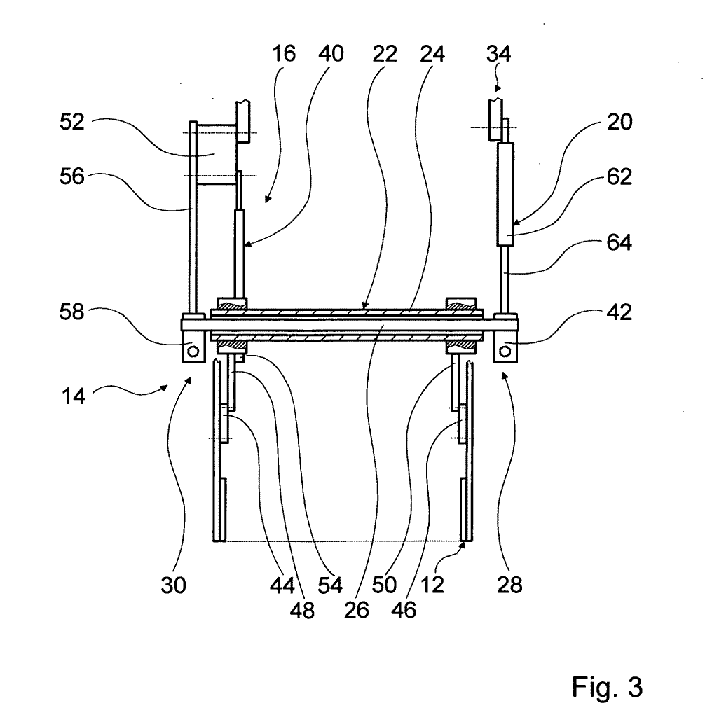

The electromotive spindle drive of the locking unit 20 is arranged in a first side region 28 of the aircraft seat or of the torsion unit 22 and the spring unit 40 is arranged in a second side region 30 of the aircraft seat or of the torsion unit 22, which side region lies opposite the first side region (FIG. 3). At its end facing the seat base, the electromotive spindle drive is mounted pivotably on the base frame unit 34 and, on its side facing the seat unit 12, is connected pivotably to a lever 42 which is connected in a rotationally fixed manner to the inner torsion rod 26 (FIGS. 2 and 3). Two levers 44, 46 are mounted pivotably on the seat unit 12, said levers being connected pivotably to two levers 48, 50 which are coupled in a rotationally fixed manner to the outer torsion rod 24. The spring unit 40 which is formed by a gas-pressurized spring or by a gas-filled cylinder unit is arranged between two levers 52, 54 of the lever mechanism, to be precise, the spring unit 40 is connected pivotably at its end facing the seat base to a first end of the lever 52 which is mounted pivotably at its second end on the base frame unit 34 (FIGS. 1 and 3). The lever 52 is furthermore connected pivotably at its first end to a first end of a lever 56 which is connected pivotably at its second end to a lever 58 which is coupled in a rotationally fixed manner to the inner torsion rod 26. At its end facing the seat unit 12, the spring unit 40 which is formed by the gas-filled cylinder unit is connected pivotably to the lever 54 which is formed integrally with the lever 48 and is connected in a rotationally fixed manner to the outer torsion rod 24 (FIG. 3). The spring unit 40 is therefore arranged in the force flux between the torsion rods 24, 26.

If, in an upright seat position, an operator or a passenger presses an operating button (not illustrated specifically), the seat unit 36 which is coupled kinematically to a bearing unit (not illustrated specifically) and the seat unit 12 are moved, driven by the electromotive spindle drive, into their end positions aligned parallel to the stand surface 32. A driving force is transferred in this case from the axially extending driving spindle 64 to the lever 42 and from the lever 42 via the inner torsion rod 26 and the levers 58, 56, 52 to the spring unit 40 and from the spring unit 40 via the lever 54 to the outer torsion rod 24 and from the outer torsion rod 24 via the levers 48, 50, 44, 46 to the seat unit 12.

After the operating button is released, the seat units 12, 36 are locked, to be precise via the electromotive spindle drive and via the locking unit 20. In a corresponding, normal adjustment operating mode, the outer and the inner torsion rods 24, 26 always revolve in common, without any movement relative to each other.

In a locked state, a bearing force acting on the seat unit 12 is transferred via the levers 44, 46, 48 and 50 to the outer torsion rod 24. The bearing force is transferred from the outer torsion rod 24 via the lever 54 and via the spring unit 40 to the lever 52 and from the lever 52 via the levers 56, 58 to the inner torsion rod 26 from which the bearing force is supported on the base frame unit 34 via the lever 42 and via the locking unit 20. The torsion unit 22 is therefore provided in order to transfer a locking torque.

If an overload situation occurs in the bed position, that overload situation arising in particular because an operator sits down on the seat unit 12 and/or the latter is loaded with an excessively high force or with a predefined overload force F, to be precise with an overload force F greater than 450 N on a frontmost edge 60 of the seat unit 12. The predefined overload force may in principle also have different values, but advantageously lies in a range between 350 N and 600 N and particularly preferably in a range between 400 N and 550 N.

The spring unit 40 has a pretension force configured to the overload force F and, in an overload situation when the locking unit 20 is locked, continues to be pretensioned or charged with a tensioning energy and, as a result, brakes the movement of the seat unit 12 such that the latter pivots slowly downward in the direction of the stand surface 32. In this case, that end of the spring unit 40 which faces the seat base is fixed by means of the locking unit 20 via the levers 52, 56, 58 and via the inner torsion rod 26 and via the lever 42, apart from a possible pivoting movement, while that end of the spring unit 40 which faces the seat unit 12 continues to be moved in the direction of the seat base unit counter to the pretension force of the spring unit 40 such that the spring unit 40 is shortened. In the process, the outer torsion rod 24 is rotated relative to the inner torsion rod 26. The delay unit 16 or the spring unit 40 is arranged upstream of the locking unit 20 or the actuator in a force flux originating from the seat unit 12, as a result of which said unit is advantageously protected from an overload.

If the overload force F is removed again, the seat unit is automatically reset by means of the spring unit 40 into its position aligned parallel to the stand surface 32 without a specific actuation by a person being required. As an alternative, a mechanism, for example a locking mechanism, could also be provided, said mechanism, in an overload situation, fixing the seat unit 12 in a certain position, for example in a position aligned perpendicularly to the stand surface 32 such that said seat unit is guided into its position aligned parallel to the stand surface 32 only after the mechanism is released. In this case, the mechanism is preferably designed such that it can be operated only by service staff and not by a passenger.

In order to achieve a braked resetting of the seat unit 12 after the overload is removed, a damping unit is integrated in the spring unit 40.

1. A seat device, in particular an aircraft seat device, with a bearing unit and with a seat unit which is mounted movably by means of the bearing unit, with a locking unit for locking the seat unit in at least one position, and with an overload protection unit which permits movement of the seat unit in the event of an overload,
wherein
the overload protection unit includes a delay unit which is provided in order to bring about a delay at least over a large part of an overload displacement.

2. The seat device as claimed in claim 1,
wherein
the delay unit comprises an energy storage unit.

3. The seat device as claimed in claim 2,
wherein
the energy storage unit is provided in order to reset the seat unit in an automated manner following an overload situation.

4. The seat device at least as claimed in claim 2,
wherein
the energy storage unit has a spring unit.

5. The seat device as claimed in claim 4,
wherein
the spring unit comprises at least one gas-pressurized spring.

6. The seat device as claimed in claim 4,
wherein
the spring unit has a pretension force configured to an overload force (F).

7. The seat device as claimed in claim 1,
wherein
the overload protection unit is provided in order to be triggered in the overload situation when the locking unit is locked.

8. The seat device as claimed in claim 1,
wherein
the overload protection unit comprises at least one torsion unit.

9. The seat device as claimed in claim 8,
wherein
the torsion unit has at least two torsion rods which are mounted rotatably with respect to each other in an overload situation.

10. The seat device as claimed in claim 9,
wherein
the torsion rods are at least partially arranged one inside the other.

11. The seat device as claimed in claim 8,
wherein
the torsion unit is provided in order to transmit a locking torque.

12. The seat device as claimed in claim 11,
wherein
the locking unit is arranged in a first side region of the torsion unit and the delay unit is arranged in a second side region of the torsion unit, which side region lies opposite the first side region.

13. The seat device as claimed in claim 1,
further comprising:
a lever mechanism, wherein the delay unit is connected to at least one lever of the lever mechanism.

14. The seat device at least as claimed in claim 1,
wherein
the seat unit is formed by a lower leg supporting unit.

15. A seat with a seat device as claimed in claim 1.

16. The seat as claimed in claim 15,
further comprising:
a stand surface, wherein the bearing unit is provided in order to align the seat unit, which is formed by a lower leg supporting unit, substantially parallel to the stand surface.
